(19) United States
(12) Patent Application Publication
(10) Pub. No.: US 2026/0191176 A1
(43) Pub. Date: Jul. 9, 2026

(54) Marine Trap Drawstring Guide Device

(71) Applicant: Randie Blanchard, Kentwood, LA (US)

(72) Inventor: Randie Blanchard, Kentwood, LA (US)

(21) Appl. No.: 19/441,322

(22) Filed: Jan. 6, 2026

Related U.S. Application Data
(60) Provisional application No. 63/742,286, filed on Jan. 6, 2025.

(51) Int. Cl. A01K 69/06

(52) U.S. Cl. CPC A01K 69/06

(57) ABSTRACT

A marine trap drawstring guide device is provided. The device is configured to minimize internal drawstring entanglement and enhance marine trap functionality. The device comprises a base member dimensioned to exceed the mesh aperture of conventional marine traps, thereby preventing passage through the trap floor and securing the device externally. A vertically oriented receiving member extends from the base and is adapted to insert through a designated opening in the bottom of the trap, serving also as a mechanical stop. The receiving member includes an internal bore that houses a guide rod for line routing. An exit member is positioned at the upper end of the guide rod to direct a drawstring into the trap interior. The drawstring, made from marine-grade synthetic fibers, is routed through the guide rod and anchored within several possible locations including the guide rod itself, the receiving member, or beneath the base member.

### CROSS-REFERENCE TO RELATED APPLICATION

The present application claims priority to, and the benefit of, U.S. Provisional Application No. 63/742,286, which was filed on Jan. 6, 2025, and is incorporated herein by reference in its entirety.

### FIELD OF THE INVENTION

The present invention relates generally to the field of marine traps. More specifically, the present invention relates to a device configured to be used in conjunction with a marine trap to minimize internal drawstring entanglement and enhance trap functionality. Accordingly, the present disclosure makes specific reference thereto. Nonetheless, it is to be appreciated that aspects of the present invention are also equally applicable to other like applications, devices, and methods of manufacture.

### BACKGROUND

Crabbing using star traps is a common method among both recreational and commercial fishermen. However, users frequently experience line entanglement during the deployment and retrieval of these traps. Line tangles can cause improper trap closure, with two sides remaining open or closing in an incorrect configuration. This malfunction often results in the loss of crabs, which compromises both the efficiency and the purpose of the activity. Additionally, the time spent untangling lines throughout the day reduces overall productivity and creates user frustration. These issues are exacerbated by underwater conditions such as current movement and limited visibility, which can contribute to the drawstring misalignment and snagging. Conventional star trap designs do not incorporate systems for actively guiding and securing the trap's drawstrings, leaving them vulnerable to tangling. The lack of integrated solutions necessitates user intervention, often requiring manual reconfiguration of the lines during or after retrieval. As a result, there is a persistent need for a mechanical solution that can reliably manage line orientation and reduce crab loss.

Therefore, there exists a long-felt need in the art for a marine trap drawstring guide device that prevents tangling of trap lines during deployment and retrieval. There also exists a long-felt need in the art for a marine trap drawstring guide device that secures drawstring alignment to ensure consistent and correct trap closure. Moreover, there exists a long-felt need in the art for a marine trap drawstring guide device that reduces crab loss caused by malfunctioning trap operation due to internal line entanglement.

The subject matter disclosed and claimed herein, in one embodiment thereof, comprises a marine trap drawstring guide device. The device is configured to minimize internal drawstring entanglement and enhance marine trap functionality. The device comprises a base member dimensioned to exceed the mesh aperture of conventional marine traps, thereby preventing passage through the trap floor and securing the device externally. A vertically oriented receiving member extends from the base and is adapted to insert through a designated opening in the bottom of the trap, serving also as a mechanical stop. The receiving member includes an internal bore that houses a guide rod for line routing. The guide rod may be fixed or removably secured by mechanisms including threaded interfaces, locking pins, or snap-fit components. An exit member is positioned at the upper end of the guide rod to direct a drawstring into the trap interior. The drawstring, made from marine-grade synthetic fibers, is routed through the guide rod and anchored within one of several possible locations including the guide rod itself, the receiving member, or beneath the base member. A method of using the device involves securing the device to the trap, routing and anchoring the drawstring, and deploying the trap such that the guide system prevents drawstring misalignment and abrasion.

In this manner, the marine trap drawstring guide device of the present invention accomplishes all the forgoing objectives and provides a device that prevents line tangles during marine trap deployment and retrieval. The incorporation of a base member and vertically aligned guide rod ensures that the drawstring is consistently directed through a defined path, which secures the correct operation of the trap closure mechanism. This configuration mitigates the risk of trap failure due to misaligned or tangled lines and minimizes the number of crabs lost as a result. By reducing the time and effort spent untangling lines, the device enhances user experience and efficiency in both recreational and professional settings. The overall design thus addresses previously unmet needs for reliability, durability, and functional integration in marine trapping systems.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a marine trap drawstring guide device. The device is an anti-tangle mechanism designed to enhance the reliability and catch efficiency of marine trapping systems, particularly star crab traps. The device manages the alignment and movement of drawstrings within the trap to ensure consistent deployment and retrieval while minimizing internal entanglement and line abrasion.

The device is comprised of a base member having a generally flat, disk-like shape with dimensions larger than the aperture size of a conventional trap mesh. This configuration prevents the base member from passing through the trap openings and allows the trap's weight to hold the base member in place without additional fasteners. The base member may be made from corrosion-resistant materials suitable for saltwater environments and may optionally include a grip element on the bottom surface to resist movement on the seabed caused by water flow or drawstring tension.

A vertically oriented receiving member extends upward from the base member and is positioned to pass through an opening in the bottom of the trap, projecting into the interior. The base member functions as a mechanical stop to prevent the receiving member from being pushed entirely through the trap during use.

The receiving member includes a vertically aligned bore configured to secure a guide rod. The guide rod forms a protected channel for drawstring operation and may be constructed from structurally durable materials resistant to marine degradation.

The guide rod may be attached to the receiving member either permanently or removably. Fixed attachment may use solvent welding, mechanical fasteners, or threaded connections. Removable configurations may include tool-free mechanisms such as locking pins, twist-locks, or snap-fit tabs to allow easy assembly and disassembly while maintaining axial retention.

The guide rod includes at least one exit member at the upper end through which the drawstring is routed. The exit member may take the form of an aperture, washer, or reinforced eyelet to guide the drawstring and reduce friction.

The drawstring may be anchored within the guide rod, within the receiving member, or at the bottom surface of the base member, depending on the configuration. Each anchoring location may utilize a fastener such as a knot, crimp sleeve, or pin. In coaxial configurations, the drawstring may pass through the entire assembly and be secured at the base member's bottom surface.

The device is also comprised of a method of use. The method involves providing the device with its component elements, inserting the receiving member through the trap bottom so the base member rests externally, securing the guide rod within the receiving member, routing the drawstring through the guide rod and exit member, anchoring the drawstring at a selected location, and deploying the trap. The grip element resists seabed movement, and the device directs the drawstring to minimize entanglement and abrasion during deployment and retrieval.

Accordingly, the marine trap drawstring guide device of the present invention is particularly advantageous as it provides a device that prevents line tangles during marine trap deployment and retrieval. The incorporation of a base member and vertically aligned guide rod ensures that the drawstring is consistently directed through a defined path, which secures the correct operation of the trap closure mechanism. This configuration mitigates the risk of trap failure due to misaligned or tangled lines and minimizes the number of crabs lost as a result. By reducing the time and effort spent untangling lines, the device enhances user experience and efficiency in both recreational and professional settings. The overall design thus addresses previously unmet needs for reliability, durability, and functional integration in marine trapping systems and overcomes the limitations of existing marine trapping devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of one potential embodiment of a marine trap drawstring guide device of the present invention while placed through a marine trap and wherein the trap is in an assembled position in accordance with the disclosed architecture;

FIG. 2 illustrates a side view of one potential embodiment of a marine trap drawstring guide device of the present invention while placed through a marine trap and wherein the trap is in an unassembled and flat position in accordance with the disclosed architecture; and

FIG. 3 illustrates a flowchart of a method of using one potential embodiment of a marine trap drawstring guide device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a marine trap drawstring guide device that prevents tangling of trap lines during deployment and retrieval. There also exists a long-felt need in the art for a marine trap drawstring guide device that secures drawstring alignment to ensure consistent and correct trap closure. Moreover, there exists a long-felt need in the art for a marine trap drawstring guide device that reduces crab loss caused by malfunctioning trap operation due to internal line entanglement.

The present invention, in one exemplary embodiment, is comprised of a marine trap drawstring guide device that improves the reliability and catch efficiency of marine trapping systems, with specific application to star crab traps. By controlling the alignment and movement of drawstrings within the trap, the mechanism supports consistent deployment and retrieval while reducing internal tangling and line wear.

A base member, shaped as a generally flat disk, forms the foundation of the device. Its dimensions exceed those of typical trap mesh apertures, which prevents the base member from passing through the openings and allows the trap's weight to hold the base securely without requiring additional fasteners. Construction materials may include corrosion-resistant options suitable for saltwater environments. An optional grip element on the bottom surface enhances seabed stability by countering movement caused by water current or drawstring tension.

Extending vertically from the base member, a receiving member is designed to pass through an opening in the trap's bottom panel and protrude into the trap interior. The base member serves as a stop that prevents the receiving member from moving completely through the trap during operation.

The receiving member is formed with a vertical bore that holds a guide rod. This guide rod creates a protected path for the drawstring and is manufactured from materials that provide structural durability and resistance to marine environmental damage.

The guide rod may be connected to the receiving member in either a permanent or removable manner. Permanent attachment may be achieved through solvent welding, mechanical fastening, or threaded connections. For removable configurations, mechanisms such as locking pins, twist-lock systems, or snap-fit tabs enable easy tool-free assembly while maintaining axial alignment during use.

Located at the upper end of the guide rod is at least one exit member that directs the drawstring into or out of the rod. The exit member may be configured as an aperture, washer, or reinforced eyelet, serving to guide the drawstring and reduce friction.

Anchoring of the drawstring can occur within the guide rod, within the receiving member, or at the base member's bottom surface, depending on the device configuration. Fasteners such as knots, crimp sleeves, or pins secure the drawstring at these locations. In certain designs where components are coaxially aligned, the drawstring passes entirely through the assembly and is anchored below the base.

A method of use for the device includes the following steps: assembling the components, inserting the receiving member through the trap's bottom so the base remains outside, securing the guide rod within the receiving member, routing the drawstring through the guide rod and exit member, selecting and implementing an anchoring method, and deploying the trap. The grip element stabilizes the base on the seabed, while the mechanism directs the drawstring to prevent tangling and abrasion throughout deployment and retrieval.

As a result, the marine trap drawstring guide device effectively addresses the problem of line entanglement during trap use. The integrated base member and vertically oriented guide rod ensure the drawstring follows a controlled path, supporting reliable operation of the trap's closure mechanism. This configuration reduces the likelihood of trap malfunction due to line misalignment or tangling, thereby minimizing crab loss. Additionally, the device enhances operational efficiency and ease of use for both commercial and recreational users. The overall design meets previously unfulfilled requirements for functional reliability, structural durability, and system integration in marine trapping applications, addressing limitations present in prior art.

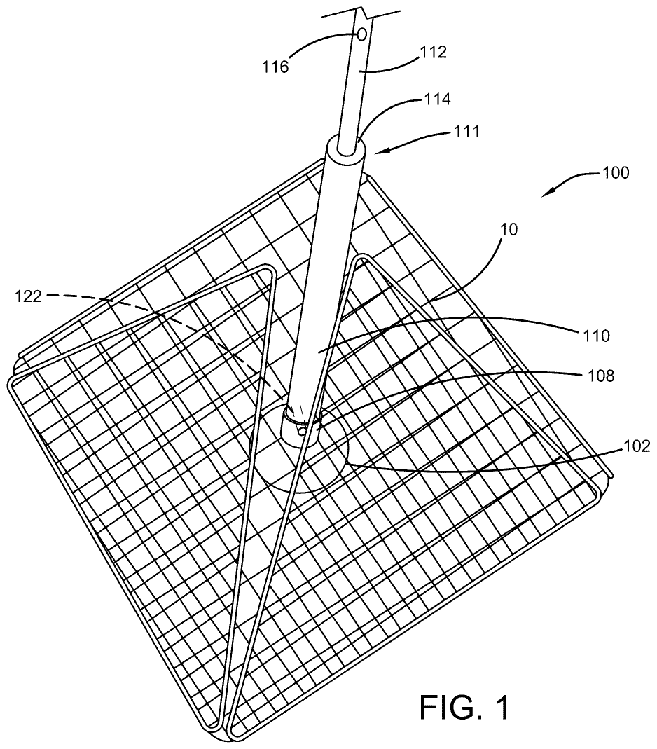

Referring initially to the drawings, FIG. 1 illustrates a perspective view of one potential embodiment of a marine trap drawstring guide device 100 of the present invention while placed through a marine trap 10 and wherein the trap 10 is in an assembled position in accordance with the disclosed architecture. The device 100 is designed as an anti-tangle mechanism engineered to improve the operational reliability and catch efficiency of marine trapping systems, particularly star crab traps 10. By managing the alignment and movement of drawstrings within the trap 10, the device 100 facilitates consistent deployment and retrieval while minimizing internal entanglement and line abrasion.

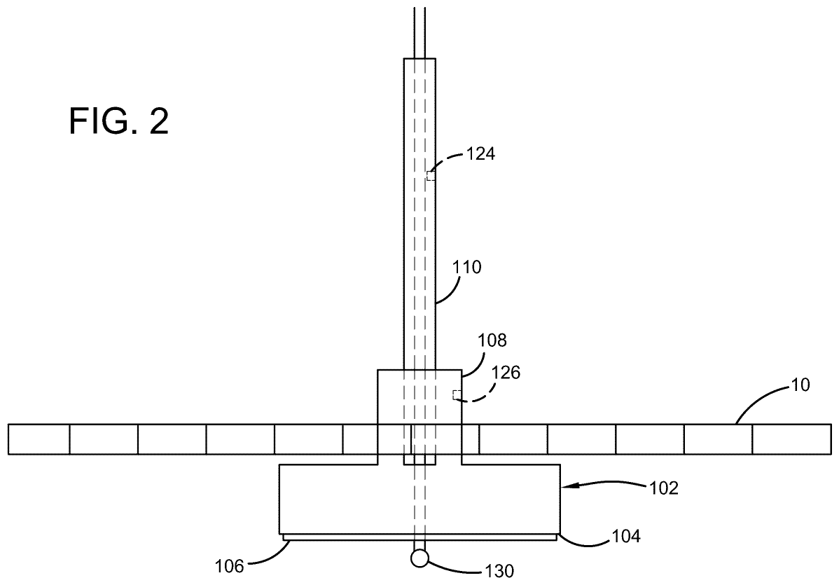

In the preferred embodiment, the device 100 comprises a base member 102 having a generally flat, disk-like form, which may adopt circular, octagonal, or other geometries to promote stability. The dimensions of the base member 102 are preferably larger than the mesh or wire aperture size of a conventional star crab trap 10 (or any other trap 10), thereby preventing the base from passing through the openings of the wire/mesh the trap 10 is made of, as best seen in FIG. 2. This dimensional relationship ensures that the weight of the trap 10 holds the base member 102 in place during use without requiring additional fasteners. The base member 102 may be constructed from marine-grade stainless steel, UV-stabilized reinforced polymer, or other corrosion-resistant and durable materials suitable for submersion in saltwater environments. A bottom surface 104 of the base member 102 may optionally include a grip element 106, such as a textured surface and/or rubberized coating, configured to resist shifting on the seabed caused by water movement or drawstring 112 tension.

Extending upward from the base member 102 is a vertically oriented receiving member 108, preferably disposed perpendicular to the bottom surface 104. The receiving member 108 is configured to pass through a designated opening in the bottom panel of the trap 10 and project into the interior of the trap 10. The base member 102 thus also serves as a mechanical stop, preventing the receiving member 108 from being pushed entirely through the bottom floor of the trap 10 during deployment or retrieval of the trap 10.

The receiving member 108 includes a vertically aligned bore designed to receive and secure a guide rod 110. The guide rod 110 provides a protected channel through which a drawstring 112 operates. The guide rod 110 may be formed from high-impact polycarbonate, UV-stabilized polymer, fiber-reinforced plastic, or other materials selected for their structural integrity and resistance to marine environmental degradation.

The guide rod 110 may be either fixedly or removably attached to the receiving member 108. In fixed configurations, the attachment may be achieved by solvent welding (for compatible plastics), mechanical fastening (e.g., stainless steel screws or rivets through aligned apertures), or threaded engagement (e.g., a male-threaded rod mated with a female-threaded bore). In removable configurations, the guide rod 110 may be secured to the receiving member 108 using a fastener 122, such as a transverse locking pin, bayonet-style twist-lock mechanism, or integrated snap-fit tabs, allowing for tool-free assembly and disassembly while ensuring axial retention during use.

An upper end 111 of the guide rod 110 includes at least one exit member 114, through which the drawstring 112 is routed into or out of the guide rod 110, as seen in FIG. 1. The exit member 114 may be formed as a simple aperture, bushing, washer, or reinforced eyelet to guide the drawstring and reduce friction at the entry point.

In various embodiments, the drawstring 112 may be anchored at different locations within the assembly. In one configuration, the drawstring 112 is anchored within the guide rod 110 using a fastener 124, such as a knot, crimp sleeve, or internal pin. In another embodiment, the drawstring 112 passes through the guide rod 110 and is anchored within the receiving member 108 using a similar fastener 126. In yet another configuration, the guide rod 110, receiving member 108, and base member 102 are all hollow and coaxially aligned, allowing the drawstring 112 to pass entirely through the assembly and exit the bottom of the base member 102, where it may be secured by a knot 130 or other external fastener engaging the bottom surface 104, as seen in FIG. 2.

The drawstring 112 may be constructed from braided nylon, polyester, or other marine-grade synthetic fibers selected for tensile strength and resistance to saltwater corrosion. In one embodiment, the drawstring 112 includes a reflective element 116, such as a woven or coated strip of light-reflective material, configured to enhance visibility during nighttime or low-light conditions to aid users in locating and handling the line.

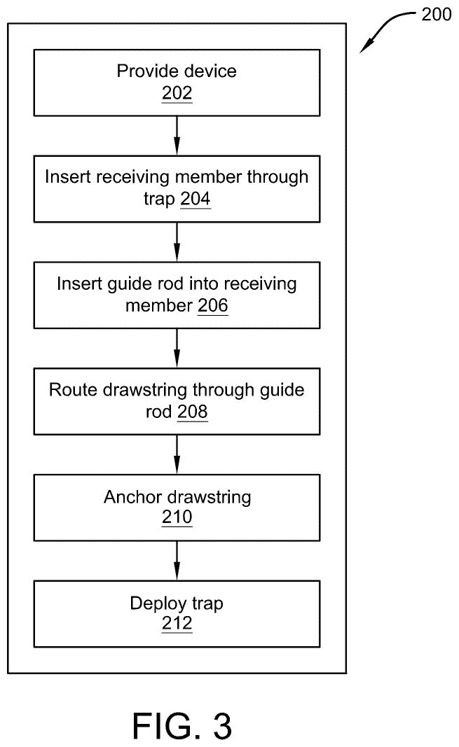

The present invention is also comprised of a method of using 200 the device 100, as seen in FIG. 3. First, a device 100 is provided comprised of a base member 102, a bottom surface 104, a grip element 106, a vertically oriented receiving member 108, a guide rod 110, a drawstring 112, and at least one exit member 114 [Step 202]. Then, the receiving member 108 is inserted through a designated opening in the bottom panel of a star crab trap 10 such that the base member 102 rests against the exterior bottom surface of the trap 10 and is prevented from passing through the trap's mesh or wire openings [Step 204]. Next, the guide rod 110 is inserted into and secured within the receiving member 108 by either a fixed or removable attachment method depending on the configuration of the device 100 [Step 206]. Then, a drawstring 112 is routed through the guide rod 110 such that it passes through the exit member 114 at the upper end 111 of the guide rod 110 and into the interior of the trap 10 [Step 208]. Next, the drawstring 112 may be anchored using a fastener, wherein the anchoring location is selected from within the guide rod 110, within the receiving member 108, or at the bottom surface 104 of the base member 102, depending on the embodiment of the device 100 [Step 210]. Finally, the trap 10 is deployed into a marine environment, wherein the grip element 106 on the bottom surface 104 resists movement of the base member 102 on the seabed, and the device 100 guides the drawstring 112 to prevent internal entanglement and line abrasion during trap deployment and retrieval of the trap 10 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “marine trap drawstring guide device” and “device” are interchangeable and refer to the marine trap drawstring guide device 100 of the present invention.

Notwithstanding the forgoing, the marine trap drawstring guide device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the marine trap drawstring guide device 100 as shown in the FIGS. are for illustrative purposes only, and that many other sizes and shapes of the marine trap drawstring guide device 100 are well within the scope of the present disclosure. Although the dimensions of the marine trap drawstring guide device 100 are important design parameters for user convenience, the marine trap drawstring guide device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A marine trap drawstring guide device comprising:
a base member;
a vertically oriented receiving member extending upward from the base member;
a guide rod received within the receiving member and extending vertically therefrom;
a drawstring routed through the guide rod; and
an exit member disposed at an upper end of the guide rod through which the drawstring is routed.

2. The marine trap drawstring guide device of claim 1, wherein the base member is comprised of a flat bottom surface.

3. The marine trap drawstring guide device of claim 2, wherein the flat bottom surface is comprised of a grip element.

4. The marine trap drawstring guide device of claim 3, wherein the grip element is comprised of a texture.

5. The marine trap drawstring guide device of claim 1, wherein the grip element is comprised of a rubberized coating.

6. The marine trap drawstring guide device of claim 1, wherein the exit member is comprised of an aperture.

7. The marine trap drawstring guide device of claim 1, wherein the exit member is comprised of a washer.

8. A marine trap drawstring guide device comprising:
a base member;
a vertically oriented receiving member extending upward from the base member;
a guide rod received within the receiving member and extending vertically therefrom, wherein the guide rod is secured within the receiving member via a fastener;
a drawstring routed through the guide rod; and
an exit member disposed at an upper end of the guide rod through which the drawstring is routed.

9. The marine trap drawstring guide device of claim 8, wherein the base member is comprised of a flat bottom surface.

10. The marine trap drawstring guide device of claim 9, wherein the flat bottom surface is comprised of a grip element.

11. The marine trap drawstring guide device of claim 10, wherein the grip element is comprised of a texture.

12. The marine trap drawstring guide device of claim 8, wherein the grip element is comprised of a rubberized coating.

13. The marine trap drawstring guide device of claim 8, wherein the exit member is comprised of an aperture.

14. The marine trap drawstring guide device of claim 8, wherein the exit member is comprised of a washer.

15. The marine trap drawstring guide device of claim 8, wherein the drawstring is comprised of a knot.

16. The marine trap drawstring guide device of claim 8, wherein the drawstring is comprised of a crimp sleeve.

17. The marine trap drawstring guide device of claim 8, wherein the drawstring is comprised of an internal pin.

18. The marine trap drawstring guide device of claim 8, wherein the drawstring passes entirely through the guide rod, receiving member, and base member.

19. The marine trap drawstring guide device of claim 8, wherein the drawstring is comprised of a reflective element.

20. A method of using a marine trap drawstring guide device, the method comprising the following steps:
providing a marine trap drawstring guide device comprised of a base member comprised of a bottom surface, a receiving member, a guide rod, a drawstring, and an exit member;
inserting the receiving member through a designated opening in a bottom panel of a marine trap such that the base member rests against an exterior bottom surface of the marine trap and is prevented from passing through an openings of the marine trap;
inserting and securing the guide rod into the receiving member;
routing the drawstring through the guide rod such that it passes through the exit member at an upper end of the guide rod and into an interior of the marine trap; and
deploying the trap into a marine environment such that marine trap drawstring guide device prevents internal entanglement and abrasion of the drawstring during deployment and retrieval of a marine trap.
